(19) United States
(12) Patent Application Publication
(10) Pub. No.: US 2005/0156915 A1
(43) Pub. Date: Jul. 21, 2005

(54) Handwritten character recording and recognition device

(76) Inventor: Edward N. Fisher, Madison, WI (US)

Correspondence Address: DEWITT ROSS & STEVENS, S.C.;Intellectual Property Department, Firstar Financial Centre, 8000 Excelsior Drive, Suite 401, Madison, WI, 53717-1914, US

(21) Appl. No.: 11/035,846

(22) Filed: Jan. 14, 2005

Related U.S. Application Data
(60) Provisional application No. 60/537,100, filed on Jan. 16, 2004.

(51) Int. Cl. G09G 5/00

(52) U.S. Cl. 345/179

(57) ABSTRACT

The invention is an electronic recording and computing device that resides within or on a pen shaped object for the purpose of recording and processing handwritten text or graphics. The device includes a writing implement (e.g., a pen or the like) which records motion during writing by tracking microscopic and/or macroscopic features of the writing surface.

### CROSS-REFERENCE TO RELATED APPLICATIONS

This application claims priority under 35 USC §119(e) to U.S. Provisional Patent Application 60/537,100 filed 16 Jan. 2004, and additionally is a continuation-in-part of U.S. application Ser. No. 10/468,751 filed 22 Aug. 2003 (which in turn claims priority under 35 USC 371 to International (PCT) Application PCT/US01/05689 filed 22 Feb. 2001), with the entireties of all of the foregoing applications being incorporated by reference herein.

### FIELD OF THE INVENTION

This document generally relates to devices that capture handwritten characters or gestures made with a pen for digital input to other computing devices.

### BACKGROUND OF THE INVENTION

The computer mouse is a relative position sensing instrument. When removed from the desktop by as little as a fraction of a millimeter, it loses track. Anyone who has tried to sign their name with a mouse knows how poorly suited it is for the task. The user interfaces of modern computers are designed to work well with mice, so the limitations of relative position sensing are offset by the computer's interface.

In digital pen devices limitations of relative position sensing become much more difficult to accept. To properly recognize handwritten communications, computers must know not only what has been written, but where it has been written. Lifting the pen from paper and moving down two lines to begin a new paragraph is as important a gesture as any stroke in a handwritten letter. Without the ability to sense the position of the pen when it is lifted from the paper, it is impossible to convey important gestural information to handwriting recognition algorithms or sketch even the most rudimentary shapes.

There have been many attempts at developing digital pen technology. Each of the approaches has different strengths and weaknesses.

Most recent attempts at digital pen technology fall into four design approaches; digitizing tablet, accelerometer, triangulation, and optical image tracking. Each of these device categories provide a relative or absolute position sensing system.

Examples of absolute position sensing systems include Anoto with its proprietary address carpet technology, consisting of thousands of tiny dots printed on the page in a recognizable pattern. Other examples include Wacom or other digitizing tablets, and triangulation based devices requiring a base unit to be clipped on a page.

Examples of relative position sensing systems includes technology from Thinkpen and OTM Technologies (WO 2069247; U.S. Pat. Nos. 6,452,683; 6,424,407; 6,330,057). These devices do not have an absolute reference like the above-mentioned triangulation base station, or specially formatted paper.

Tablet based pen systems such as those described in U.S. Pat. No. 6,278,440 and manufactured by Wacom, Inc. have been in use for over thirty years. Although improvements in power consumption and reductions in manufacturing cost have made them suitable for battery operation and mass production, the sheer bulk of the tablet, which defines the available writing area, has limited such systems to use in niche applications and as a PC mouse alternative for sufferers of repetition strain injuries. To their credit, tablet systems offer very high accuracy and absolute positioning.

Accelerometer based pen systems must determine position indirectly from acceleration and the direction of gravity. To derive position data from acceleration a double integral with respect to time must be performed. This introduces numerical errors and other cumulative error effects. In the presence of the confounding effects of gravity, constantly changing pen attitude, and movement of the user and/or writing surface during operation, these devices do not provide sufficiently accurate relative position information to make them useful.

Triangulation based approaches, including InkLink from Seiko, N-scribe, and E-pen (U.S. Pat. No. 5,977,958) distributed by Casio, use an external device that contains two sensors attached to the writing surface and a sensor in the pen to triangulate the position of the pen tip. To maintain reasonable accuracy the distance between the two sensors must be a significant fraction of the size of the writing surface. Additionally, the pen cannot be brought too close to the triangulation device because the three points that form the triangle degenerate to defining a line containing the three points. Both the pen and the sensor unit require power, so for portable applications two sets of batteries must be maintained. The sum of these problems results in a device that has the appeal of a pen and paper without the simplicity of operation.

Finally, image based optical tracking methods, including products by Anoto AB and Finger System (U.S. 20030112220; EP1342151; KR2001016506; KR2001082461; KR2001067896), use a CMOS or CCD camera to track features on the writing surface as the pen moves across it. The difficulty with this approach is maintaining accurate position information when the pen is lifted from the writing surface. Anoto uses a special pattern of dots printed on the page that are encoded with position information. This provides the device with absolute positioning information when the tip is on the page and therefore it does not need to sense motion when off the writing surface. The disadvantage is if the patterned paper is not available the device cannot be used.

There are significant challenges in employing an image based tracking approach on a wide variety of surfaces without a preprinted pattern. Many types of modern paper are of uniform color, without even the smallest of discolorations—even when viewed under magnification. If all the pixels of the image sensor detect the same color, it is impossible to track motion across the writing surface. Fortunately, these papers invariably have a micro-textured surface formed as a result of manufacturing the paper. For common photocopy paper these features lie in the range of 20 to 300 microns (le-6 meters) and have a depth of 5 to 15 microns.

Two digital pen devices in the prior art cast light onto the writing surface at a substantially low angle of incidence (˜70 degrees from perpendicular). This has the effect of lighting one side of the micro-textured surface while casting shadows across the other side of these micro-textured features (see FIG. 2). The contrast formed from lighting one side of theses surface features and not the other become features that can be tracked by the optical navigation software. However, if the lighting source is fixed on the pen, it is difficult to maintain uniform illumination of the surface while the pen is being used. As the user writes with the pen device, the angle of incident light relative to the writing surface is continuously changing. This causes changes in the illumination pattern on the page, and results in errors produced by the optical navigation software, which assumes constant unchanging illumination.

Although absolute positioning is preferred for its accuracy, there is no suitable absolute reference for the digital pen application space. Thus, there is a need for a digitally enabled pen solution that can achieve a high level of relative position sensing accuracy on a wide range of writing or marking surfaces.

It is not sufficient to cast light on the page at a low angle of incidence when employing image tracking approaches on colorless or single colored surfaces. It is necessary to provide a lighting solution that will illuminate the page with a high degree of similarity throughout the normal operating motion of the device.

Most imaging systems require focusing and refocusing when the image to object distance changes. If the writing surface is viewed by the camera at some orientation other than coplanar to the page some portions of the image may be magnified, demagnified, focused, or defocused.

A problem for image based tracking is the image sensor sees a projection of the page onto the image sensor. This causes the image to distort based on two factors; first, magnification is a function of distance, and second, dimension (x and/or y) is a function of angle of inclination and scales based on the mathematics of right triangles. This distortion occurs even when telecentric optics are used. It is important to recognize and correct acquired data for these effects for more accurate reproduction of user handwriting.

There are many techniques for detecting the angle of one object in relation to another. Many techniques use the direction of gravity as a reference for making angular measurements. Gravity acts on objects with mass and all sensors that use gravity as a reference use some sort of massive element to sense the direction of gravity. In the case of digital writing devices this is an undesirable approach for several reasons. One reason is that there is no guarantee that the writing surface will be perpendicular to gravity, like a piece of paper lying flat on a desk. The second reason is that any sensor that is subject to the forces of gravity are also subject to inertia. A pen in use represents an object with mass in motion The direction and speed of motion is continuously changing. This motion creates inertial forces on the massive elements of gravity sensors. This has the effect of adding large amounts of noise to the detected angle or change in position and makes this type of sensor impractical for this application.

### BRIEF DESCRIPTION OF THE DRAWINGS

FIG. 1: A schematic view (not to scale) of the handwriting digital input device showing many of the internal components thereof.

FIG. 2: A schematic view of a cross-section of a piece of paper showing the micro-textured surface commonly seen under magnification.

FIG. 3: A schematic representation of the effect of angle when a camera images a page.

FIG. 4: A schematic representation of a telecentric optical system.

FIG. 5: A schematic representation of the distance sensing integrating sphere.

FIG. 6: A flowchart of how data is acquired and processed by the digital input device.

FIG. 7: A view showing a block letter 700, the distorted block letter as seen through a non-telecentric lens system 701, and the distorted block letter as seen through a telecentric lens system 702.

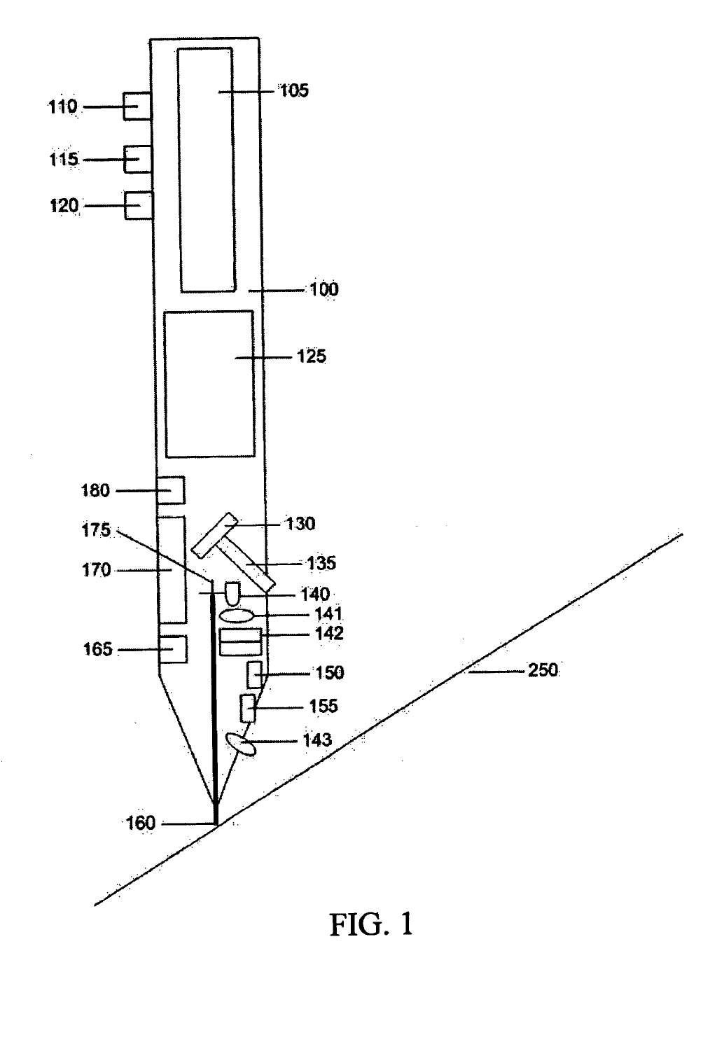

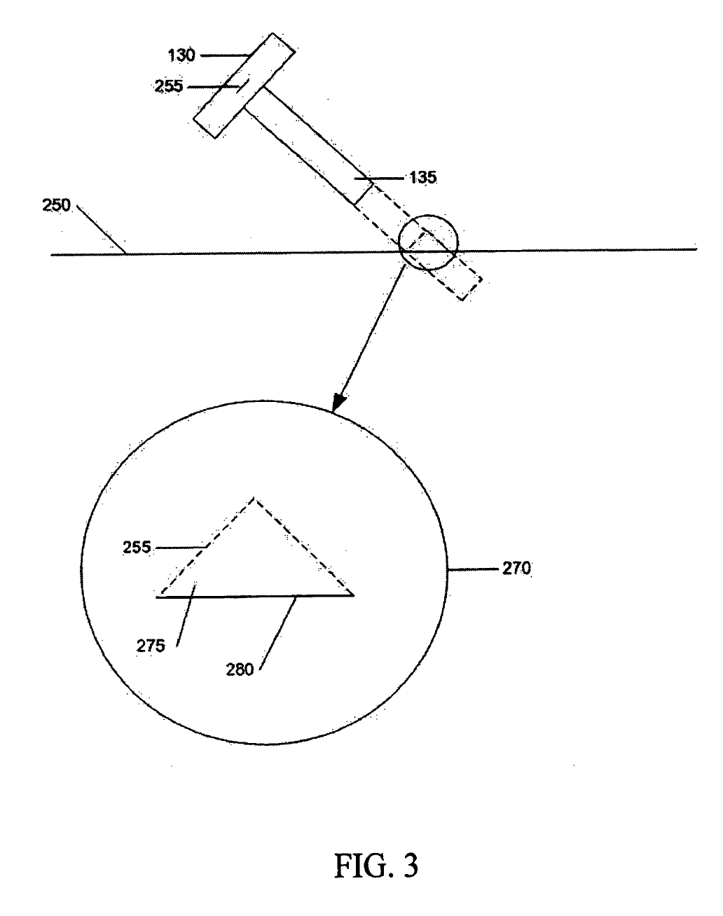

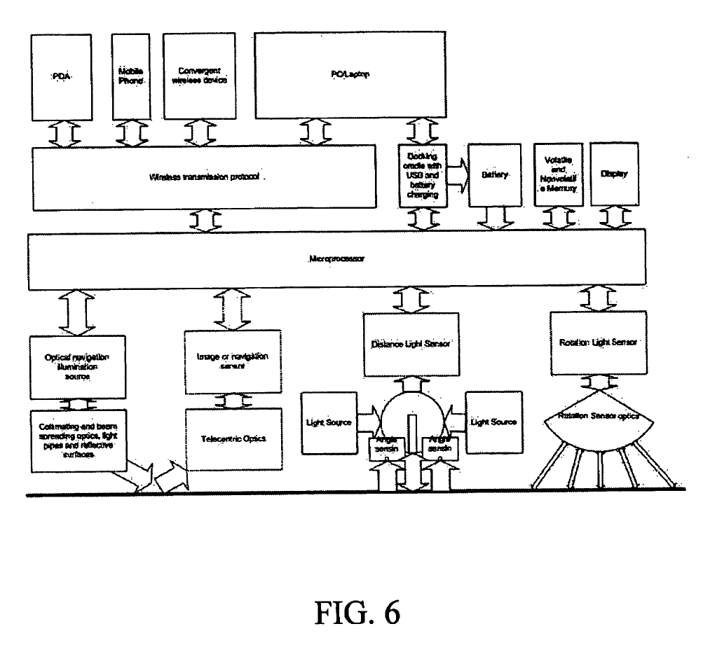

Detailed Description of Preferred Versions of the Invention A version of the present invention, formed as a pen capable of capturing handwritten information for immediate transmission to another device, or for storage and later transmission to another computing device, is shown in FIG. 1. The device is supported by its outer structure 100, generally shaped like a pen or other marking instrument. Inside the pen 100 is an embedded computer 125 that preferably includes the features depicted in FIG. 6, such as a microprocessor, memory, wired and wireless communications, and interfaces to various sensors (orientation sensor 150, distance sensor 155, and feature imaging sensor 255, to be discussed below, wherein the feature imaging sensor 255, which is shown in FIG. 3, is part of the optical navigation imaging system 130 shown in FIG. 1).

Operation of this version of the device is preferably restricted to a “fountain pen” type of motion, that is, the pen 100 is held such that its angle of inclination only changes in a single axis (though a fair amount of tolerance may be built into the device to ease this restriction on the user). This restriction, which can be imposed by ergonomically shaping the pen 100 so that it is most comfortably gripped when inclined only along one plane (i.e., it will have finger grips/contours formed so that it will be uncomfortable for a user to grip the device otherwise), is useful so that the sensors (orientation sensor 150, distance sensor 155, and feature imaging sensor 255) are maintained facing the page. It also simplifies navigation calculations and the number of sensors that must reside on the pen. However, if the restriction is undesirable, other versions of the invention may have sensors arranged to capture two or three orthogonal components of angle, thus reducing or eliminating the fountain pen restriction of motion.

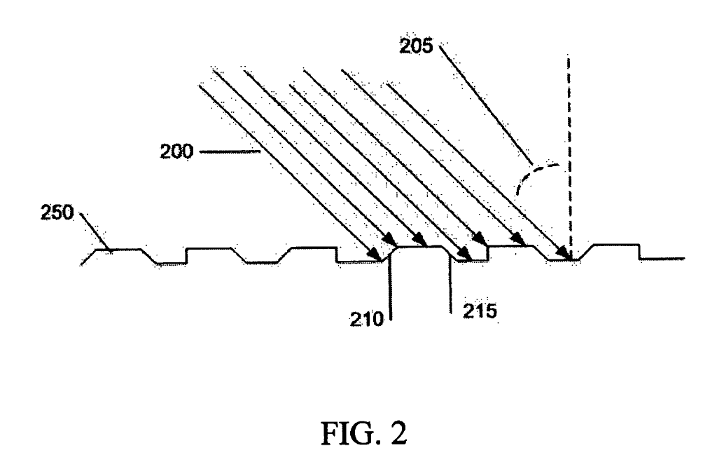

The pen 100 preferably includes several optical systems that interact with each other in preferred ways to be described below. Each basically operates on the principle that an illumination pattern 200 (FIG. 2) from the light source(s) of the pen 100 casts light on the writing surface, and this light is reflected and scattered in all directions, with a portion returning to a particular light sensor on the pen 100.

Image Sensing and Telecentric Optics

Optical image tracking of the writing surface is accomplished by the optical navigation imaging system 130 of FIG. 1, with this optical navigation imaging system 130 including a CMOS or CCD feature imaging sensor 255 (e.g., FIG. 3) and optical navigation software, such as those available in the ADNS-2051 (Agilent Technologies, Palo Alto, Calif., USA) line of optical mouse chips. The feature imaging sensor 255, which is analogous to a camera, is capable of imaging the page hundreds to thousands of times per second. These images are analyzed by the optical navigation software that mathematically compares the sequential stream of images, and determines direction and amount of motion based on the change in features between successive images.

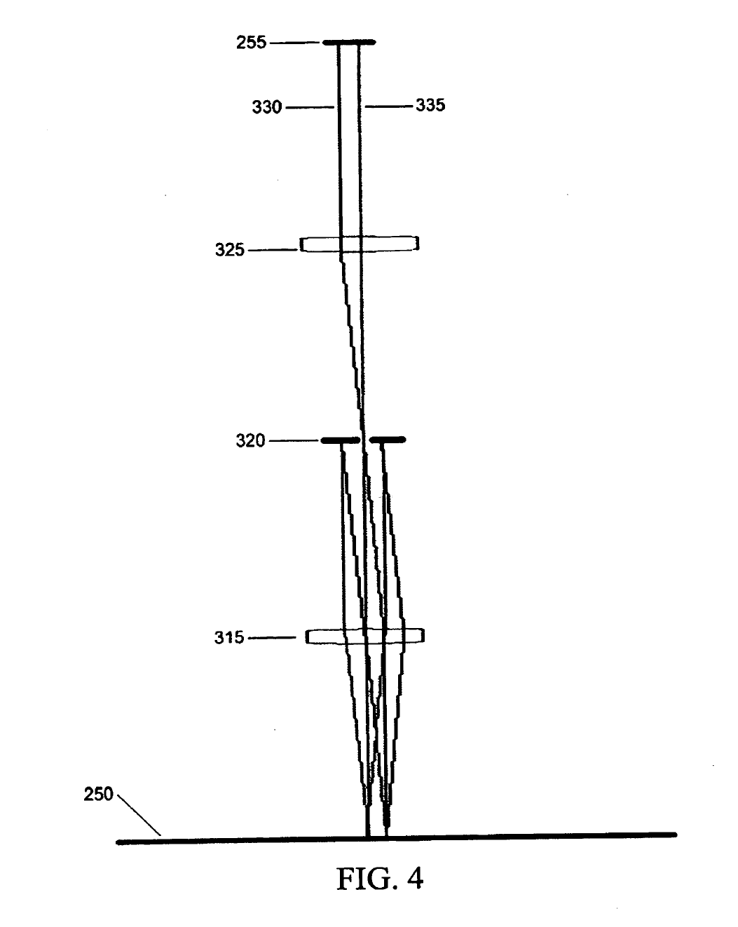

The optical navigation imaging system 130 requires a set of optical components that will project an image onto its feature imaging sensor 255. The optical system is preferably a telecentric optical system 135, i.e., a lens system that delivers an image of constant magnification as a function of distance from the objective lens to the objective and contains a telecentric stop or aperture located at one of the focal points of the system. Further information on telecentric systems can be found, e.g., in U.S. Pat. No. 6,580,518, U.S. Pat. No. 6,614,539, U.S. Pat. No. 6,614,957, U.S. Pat. No. 6,624,879, and U.S. Pat. No. 6,624,919. Although telecentricity may be attained in a number of ways, the pen 100 preferably uses a system such as that shown in FIG. 4, with two double convex spherical lenses 315, 325. Telecentricity results when an aperture 320 is placed at one of the focal points of the system. This blocks all rays of light except those parallel 330, 335 to the optic axis. This creates an area of telecentricity that is equal to the area of the entrance pupil or exit pupil of the optical system.

Referring to FIG. 3, the telecentric optical system 135 will see only a projection 255 of the writing surface 250 as a function of angle between the writing surface 250 and the optic axis of the optical system 135. This has the effect of reducing the apparent size of an imaged feature of the writing surface 250—an effect referred to herein as “perspective error”- and this can generate error when motion is calculated (since motion is determined by comparing the appearance of writing surface features between successive captured images of the writing surface 250). If the angle of the optical system 135 relative to the writing surface 250 is known, this perspective error effect can be mathematically reduced or eliminated using simple trigonometric relations. Thus, it is useful to include some means of measuring the orientation of the optical system 135 relative to the page, as will be discussed later in this document.

Optical Navigation Illumination

When the feature imaging sensor 255 images a writing surface 250, it relies on changes in features between captured images of the writing surface 250 to track motion. In the case of plain white paper—which is the most likely writing surface 250 for the pen 100 to be used on—there are few if any discolorations to track. Thus, a writing surface 250 having a single color requires a specialized lighting solution if the pen 100 is to work well. Fortunately, paper (and most other common writing surfaces 250) has a micro-texture, as depicted in FIG. 2, formed during the manufacturing process and made up of individual fibers of the paper. These features tend to be sized in the range of 50 microns to 250 microns with a depth around 5 to 15 microns. If light is cast at a grazing angle 205 of incidence 200, these features may be imaged by the feature imaging sensor 255 because of the difference in contrast of the lighted side 210 and the dark side 215 of the micro-textured writing surface 250. Thus, the contrast resulting from light and dark areas on the writing surface 250 provide data that can be used for navigation.

The illumination system preferably includes an LED 140 (preferably an infrared LED or LED transmitting light at some other non-visible wavelengths), a double convex lens 141, two plano-concave barrel lenses 142 with the two lines of focus perpendicular to each other, and a convex mirror 143. This provides a precisely formed “fan array” beam, such that it illuminates the writing surface 250 in a stripe from the pen tip 160 back to the area that the optical system 135 (and its feature imaging sensor 255) images the page 250 when the pen 100 is in a position vertical to the writing surface 250 (and several inches from it). The width of the beam is sufficiently wide to illuminate the portion of the writing surface 250 imaged by the feature imaging sensor 255 through a range of motion between the pen 100 being perpendicular to the writing surface 250, to the pen 100 being about sixty degrees from perpendicular, in the plane of motion allowed by the ergonomic design of the pen 100. The beam “footprint” is also designed such that the portion of the writing surface 250 imaged by the feature image sensor 255 is illuminated throughout that full range of angle, and while the pen 100 is lifted from contact with the writing surface 250 to several inches from the writing surface 250. Thus, the illumination system will illuminate the portion of the writing surface 250 imaged by the optical system 135 (and its feature imaging sensor 255) when the pen 100 is moved anywhere in its specified range of motion. That range of motion is any combination of angle 275 and distance from the writing surface 250 with practical limits of angle and distance.

When the pen 100 is used for writing in a conventional manner, the orientation of the pen 100 will always be changing. This is a problem because if the angle of incidence of the light changes as the person operates the pen 100, contrast features 210/215 on the writing surface 250 will also change, and this can lead to error because the features captured in successive images will appear to change. To solve this problem it is useful to have the illumination source (here, effectively the mirror 143 which emits the light of the LED 140 from the pen 100) located very close to the tip 160 of the pen 100. The emitted fan array of light is preferably at least as wide as the feature imaging sensor 255 (if 1:1 imaging is used), and parallel to the axis of the pen. In this way, when the user changes the angle of inclination of the pen 100, the light cast on the writing surface 250 at the location of the imaged portion of the page is effectively independent of the angle of the pen 100. In practice it is difficult to place an illumination source exactly at the writing tip 160 of the pen 100; however, one may be placed sufficiently close to the tip 160 as to approximate that location.

Orientation Sensing

The purpose of the orientation sensing system is to determine the angle of inclination and distance of the pen 100 relative to the writing or marking surface 250. This information can be used to correct the aforementioned perspective error viewed through the telecentric optical system 135.

FIG. 3 shows the source of the perspective error within circle 270. The plane of the page in FIG. 3 is the plane that defines the restriction of motion of the pen 100 (i.e., consider that the pen 100 is restricted to tilt within the plane of the page bearing FIG. 3). Looking to the circle 270, when the pen 100 moves in this plane by a distance equal to 280, it will only sense a change in position equal to 255. The apparent motion is a function of the angle between the optical axis of the optical system 135 and the writing surface 250. The relation is:
[Actual motion 280]=[Apparent motion 255]/[cos q]
where q is the angle 275 between the feature imaging sensor 255 and the writing surface 250. (Note that distance between the optical system 135 and its feature image sensor 255 does not appear in this relation because telecentricity eliminates distance as an independent variable. If telecentricity is not used, distance must be taken into account.)

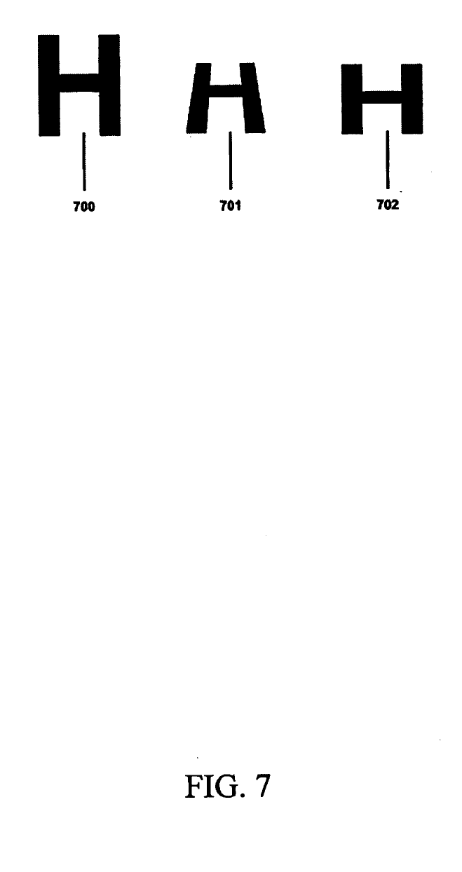

Thus, referring to FIG. 7, if the feature imaging sensor 255 viewed the letter H, it would look like the character 700 if the feature imaging sensor 255 was coplanar with the writing surface 250. However, if the angle between the feature imaging sensor 255 and the page had a q angle (275 in FIG. 3) of approximately 45 degrees, the H would look like 702 (provided the optical system 135 is telecentric). The H would look like 701 if the lens system is not telecentric. The distortion of the image seen in 701 is a direct result of magnification being a function of distance.

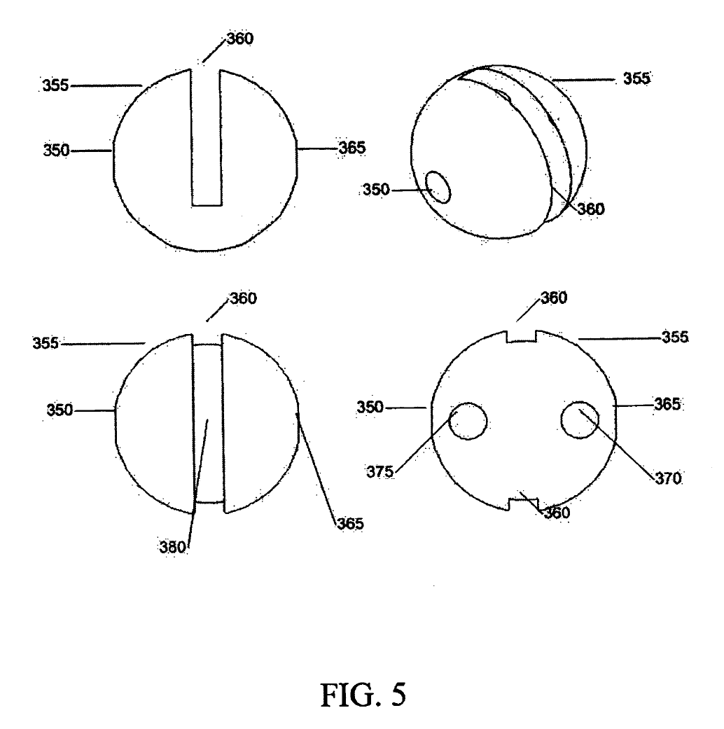

To allow determination of angle q and thereby compensate for distortion of the image 702, an orientation sensor 150 (as depicted in an exemplary location in FIG. 1, and shown in FIG. 5 as “Angle Sensing”) may be used. The orientation sensor 150 may be simply formed of (for example) a planar light sensor such as a silicon photodiode. If an orientation sensor illumination source casts light of uniform intensity onto the writing surface 250, with such light intensity being made insensitive to the angle of inclination of the pen 100 with respect to the writing surface 250 (i.e., such that light intensity will not change as the orientation of the pen 100 changes), the orientation sensor 150—whose angle with respect to the writing surface 250 will change with pen 100 orientation—will detect an amount of this light which is dependent on the angle of the pen 100, thereby allowing a measure of pen orientation. A calibration reading at a known angle allows for relative measurement of angle. While the pen 100 may incorporate a separate orientation sensor illumination source (one which is dedicated to casting light which is only detected by the orientation sensor 150), a preferred approach is to use the distance sensor illumination source (discussed below) as the orientation sensor illumination source as well. It is also preferred to use more than one orientation sensor 150—for example, by placing a photodiode on opposite sides of the orientation sensor illumination source—and averaging their results, so as to reduce the fountain pen restriction of user pen motion (i.e., so that deviations from the planar motion restriction mentioned earlier have little or no effect).

Note that the orientation sensor illumination source and the orientation sensor preferably transmit and detect light in different wavelength ranges than those of the LED 140 (i.e., the feature imaging sensor illumination source), so that there is no need to compensate for crosstalk effects.

Distance Sensing—Angle Calibration

When the user lifts the pen 100 above the writing surface 250, the calibration reading taken for the angle will no longer be valid. To account for this, it is useful to have the pen 100 include a distance sensor 155, preferably an optical one rather than an inertial or other distance sensor. A variant of the integrating sphere may be used as a distance sensor 155. Referring to FIG. 5, the sphere has a light source (or sources) which provide light to the hollow interior of the sphere through cutouts 350/365. The light scatters off the interior Lambertian surface 380 of the sphere and leaves the sphere through the slit 360. This light reflects and scatters off the writing surface 250, and some reenters the sphere through the slit 360. Owing to the properties of the sphere, an integration is performed on the entering light such that light intensity is effectively the same at all points on the sphere's interior, and thus a photodiode or other light sensor (or light sensors) provided at one or more points will be able to monitor the entering light (plus the emitted light, which has nonvarying intensity). Thus, as the distance from the sphere 355 and the writing surface 250 changes, the amount of light detected by a light sensor (or sensors) through holes 370 and 375 changes. When the slit 360 is made to extend more than half way around the sphere, it will project the exact same pattern of light invariant to angle in a range of the angle subtended by the slit 360 minus 180 degrees, so long as rotation occurs in the plane defined by the long dimension of the slit 360 and the center of the sphere. The emitting cutouts 350/365 and receiving holes 370/375 are preferably made as small as possible to maintain accuracy of the integration, so that any light leaving the sphere will have uniform intensity; note that the light emitters and light sensors need not be situated directly in the emitting cutouts 350/365 and receiving holes 370/375, and may instead transmit and receive light via light pipes situated in the emitting cutouts 350/365 and receiving holes 370/375. If needed, baffles may be placed strategically inside the sphere to minimize the non-ideal effects of the emitting cutouts 350/365 and receiving holes 370/375. Other examples of integrating spheres are seen, for example, in U.S. Pat. No. 459,919, U.S. Pat. No. 6,546,797, and U.S. Pat. No. 6,628,398.

Thus, the distance sensor 155, including the sphere and its light sources and sensors, produces a signal proportional to the distance between the distance sensor 155 and the writing surface 250. As the pen 100 is lifted off the writing surface 250, the distance signal reading from the distance sensor 155 changes, and the angle signal from the orientation sensor 150 changes as well. Solution of an ordinary differential equation allows determination of both angle and distance, which can then be used to correct distorted navigation data from the optical navigation system 130.

Force Sensing

The tip 160 of the pen 100 may be a ballpoint pen, pencil, or personal digital assistant (PDA) stylus. This tip 160 is preferably fastened to a cartridge that engages a force sensor 175 capable of detecting a force exerted on the tip 160 by the user during writing. The force sensor 175 could use a combination of a spring and hall effect sensor, a piezometric sensor, or any one or more of a number of different commercially available force/pressure sensors. The signal detected by the force sensor 175 advises when the user lifts the pen 100 from the paper, and thus indicates when written characters “start” and “end,” and when pen-to-writing surface distance must be tracked for accurate motion determination. The force sensor 175 can also be used for features such as signature authentication (since individuals tend to apply unique pressures at unique times as they write their signatures), and to vary the “breadth of stroke” of written data (e.g., when a user writes with greater pressure, the pen 100 may store the written characters with thicker lines).

A preferable option is to allow the tip 160 to be interchangeably formed of a ballpoint ink cartridge and a stylus tip such as those used in PDA's. In this way the user may switch the tip 160 for paper use to PDA use without the need to change between different writing devices.

User Interface

FIG. 1 shows an exemplary user interface arrangement. Several buttons 110, 115, and 120 are included along with a display 105 for a user interface. Additionally, at the writing end of the device there are an additional two buttons 165 and 180, and a scroll pad 170, that can be used to duplicate the function of a conventional two button scroll-wheel mouse. However, it should be understood that a wide variety of other interface options are possible.

Processing

The components of the preferred version of the invention described above work under the control of the embedded computer 125, which executes a program that collects data from the sensors discussed above. The result is accurate tracking of the position of the pen 100 as it moves across and over the writing surface 250. This position information can then be stored or transmitted via wireless or wired communications methods.

Use of the Invention

Following is a description of a preferred methodology for using the invention to capture information. The following methodology is described because it is believed novel and particularly advantageous; however, it should be understood that other operating methods are possible.

The pen 100 senses its position using the aforementioned sensors. Light is cast on the writing surface 250 through the sensor window. When the pen 100 moves such that it cannot correlate features of one or more captured images with features in successive captured images, or orientation sensors indicate an invalid position of the pen, it is unable to accurately track its position. Throughout this document the term “page lock” will be used to identify when the pen is positioned so that it can properly track its motion relative to the writing surface 250. The time between a page lock event and a loss of page lock is called a session.

In continuous mode, a user simply starts writing and his/her notes will automatically be stored in memory. Subsequent sessions are combined in the same file by placing them just below the previous session, as if the user simply skipped to the next line in the page. In a sense, the file can be thought of as a continuous roll of virtual paper. To create a new document the new page button (e.g., one of 110, 115, and 120) is pressed. The pen 100 will close the previous document, create a new one and wait for new handwritten information. A disadvantage of continuous mode is that a user cannot effectively work on the same section of the same document during different sessions (e.g., cannot effectively insert words or lines in previously written text), since later sessions will be stored later in the file.

This limitation is overcome if the pen 100 is operated in page mode. In page mode, the currently loaded file (page) is determined by the last page entry. To create a new page, a user writes the page name or number anywhere on the writing surface 250 while pressing the page button. Any number of characters or symbols may be used as the pagination mark. The pen 100 uses this information for two things. First, the page number entered is recognized and included in the filename for ease of file recognition and organization. Second, the pen uses the position and orientation of the page number as a reference to the previous session. In other words, once page lock is lost, the user can start a new session on the same page by simply tracing over a previously-written page name or number while depressing the pagination button, and then resuming writing where the last session left off. This allows a user to add information to a page and have everything appear in the correct locations across multiple sessions. A user can therefore take a break from writing, and later come back and work on the same drawing or document while maintaining an accurate electronic representation of the written work.

The pen's PC application can be invoked by placing the pen in the cradle or by running the program through the Start->Program Files shortcut. When the pen is inserted in the cradle all files are automatically transferred to the computer in a location the PC application is aware of. Upon return to the PC the user may integrate this information, through the use of the digital pen's PC application, with their existing information and document management systems already established on the PC.

In Closing

The description set out above is merely of exemplary preferred versions of the invention, and it is contemplated that numerous additions and modifications can be made. As examples, additional sensors 150/155/255 might be used (or might be of types other than those noted, e.g., the orientation sensor 150 might be an inertial sensor), and/or components of the various sensor systems may be combined (e.g., the illumination sources for the sensors 150/155/255 might be combined). However, these examples should not be construed as describing the only possible versions of the invention, and the true scope of the invention extends to all versions which are literally encompassed by (or equivalent to) the following claims.

1. A handwriting implement wherein the implement may be manipulated over a writing surface to simulate or generate the creation of written matter, and wherein such manipulation generates machine-readable data representing the written matter, the implement comprising:
a. a motion tracking imaging system which images features of the writing surface so that comparison of features between successive images can be used to track motion of the implement, the motion tracking imaging system including:
(1) a light source which emits incident light onto the writing surface, such light preferably being:
(a) in the non-visible spectrum; and/or
(b) projected onto the writing surface in a fan-shaped beam, whereby a stripe of light is projected onto the writing surface; and/or
(c) projected onto the writing surface at a grazing angle oriented more closely parallel to the plane of the writing surface than perpendicular to it;
(2) a lens system through which images of the lighted writing surface pass, the lens system preferably being telecentric;
(3) a feature imaging sensor capturing images of the writing surface from the lens system;
b. an orientation sensing system which provides a measure of the orientation of the implement to allow compensation for perspective error in imaged features of the writing surface, the orientation sensing system including:
(1) a light source which emits incident light onto the writing surface, such incident light having at least substantially uniform intensity as the implement is reoriented about a perpendicular to the writing surface;
(2) an orientation sensor on the implement (and preferably having a fixed orientation thereon) which detects light reflected from the writing surface and provides an orientation signal therefrom;
c. a distance sensor which provides a measure of the distance of the implement from the writing surface to allow compensation of orientation measurements when the implement is lifted from the writing surface, the orientation sensing system including:
(1) a light source which emits incident light onto the writing surface, such incident light having at least substantially uniform intensity, and wherein the light source of the distance sensor may be the same as the light source for the orientation sensor;
(2) a distance sensor on the implement which detects light reflected from the writing surface and provides a distance signal therefrom;
d. a processor receiving:
(1) the captured images from the image sensor,
(2) the orientation signal, and
(3) the distance signal,
during the motion of the implement over the writing surface, and generating data therefrom representing the motion of the implement over the writing surface.
